(19) United States
(12) Patent Application Publication
(10) Pub. No.: US 2023/0311046 A1
(43) Pub. Date: Oct. 5, 2023

(54) IMPROVEMENTS IN OR RELATING TO FILTERS

(71) Applicant: Alchemie Technology Limited, Cambridge (GB)

(72) Inventor: Simon KEW, Cambridge (GB)

(73) Assignee: Alchemie Technology Limited, Cambridge (GB)

(21) Appl. No.: 18/042,372

(22) PCT Filed: Aug. 20, 2021
(86) PCT No.: PCT/GB2021/052165

§ 371 Date: Feb. 21, 2023

(30) Foreign Application Priority Data
Aug. 21, 2020 (GB) 2013116.5

(51) Int. Cl. B01D 46/00; B01D 39/08; A62B 23/02; A62B 18/02; A62B 18/08; F24F 8/108

(52) U.S. Cl. CPC B01D 46/0028; B01D 46/0001; B01D 39/08; A62B 23/025; A62B 18/025; A62B 18/084; F24F 8/108; B01D 2279/65; B01D 2239/0442; B01D 2239/0478; B01D 2239/10

(57) ABSTRACT

A removable filter is provided. The filter comprises a porous substrate; and an anti-pathogenic coating provided on at least part of the porous substrate. The concentration of the coating varies across the substrate to provide a coating pattern.

The present invention relates to improvements relating to disposable filters of a type suitable for use in a washable face mask; an automotive HVAC system or an air purification device for a room or part of a building

Filters are commonly used to remove particles from air which may contain pathogenic species such as viruses, bacteria and fungi. These filters are deployed in products such as facemasks; air filters in air conditioning systems; in cars to filter incoming air. The filter technologies are usually based on porous materials that trap particles of solids and liquids as air flows through the porous medium. However, once trapped by the porous media the pathogenic species remains live and has the potential to cause harm via physical contact or aspiration into the air flow.

It is possible to inactivate pathogenic species with chemistries that inactivate or kill on contact. Examples of well-known chemistries include small-molecule anti-biotics such as amoxicillin, doxycycline, cephalexin, ciprofloxacin, clindamycin, metronidazole, azithromycin, sulfamethoxazole and trimethoprim; solvents such as ethanol, isopropanol and methanol, elements such as iodine, bromine; metal ions silver, copper, gold; reactive species such as hydrogen peroxide, ozone, hydroxl radicals. These chemistries can be applied to filters to ensure that any entrapped pathogens are inactivated or killed. The amount of chemistry required to be effective is generally relatively low <10 wt % and for high potency chemistries <0.1 wt % may be the target wet add-on, i.e. the percentage of wet coating onto dry substrate.

Currently deployed processes for applying antiviral or antibacterial chemistry to filter materials include pad coating, spray coating or rotary screen printing. The aim to provide a homogeneous, thin layer of coating applied across the filter surface, but these techniques often fall short.

The most common approach for coating liquid chemistries onto porous fabric media on a roll is pad coating, which involves full immersion of the substrate in a liquid bath and roller compression of the substrate, resulting in an unavoidably high level of wet pick-up (liquid addition), which in turn leads to loss of porosity and overdosing of the chemistry.

Traditional spray coating can also be challenging onto porous material on a roll, since the spray velocity is generally high (>30 m/sec), which can damage and compress the porous substrate structure, leading to pores being filled with fluid. In addition, spraying often does not penetrate porous media without significant overdosing of the chemistry. This leads to high levels of filled pores and heterogeneous application of the coating chemistry. This also leads to high levels of wet pick-up being required and as with pad coating, loss of porosity and overdosing of the chemistry. Spray coating is feasible for discrete filter components; however it is not possible to deliver 2D spray patterns without masking. Furthermore, there is typically limited control over penetration of the fluid into the filter articles.

Rotary screen printing is a further option for coating the filter material on a roll. However this also delivers significant compression to the substrates.

All of these traditional coating techniques have limited capability to control the three-dimensional placement of the coating within the porous structure. There is no control over the level of penetration of the coating within the substrate. Only rotary screen printing has the capability to deliver 2D patterning, but this, along with the other techniques, results in the overdosing of the fluid and consequent pore infill.

It is against this background that the present invention has arisen.

According to the present invention there is provided a removable filter for a face mask, the filter comprising: a porous substrate; and an anti-pathogenic coating provided on at least part of the porous substrate. The concentration of the coating varies across the substrate to provide a coating pattern. A coating pattern is especially applicable with a particularly strong or effective coating where a complete coverage of the substrate would provide excessively high loading of the anti-pathogenic agent.

The filter is removable because it needs to be replaced with the anti-pathogenic coating becomes ineffective. This allows the mask to be washed and a new filter inserted. This reduces overall waste caused by single use masks.

The porous substrate is designed to filter the air to remove large droplets, aerosol droplets and particulate contaminants.

The anti-pathogenic coating is provided to inactivate or kill pathogens captures in the pores of the porous substrate. This ensures that the pathogens cannot multiply and/or be transferred from the face mask onto the face of the user or onto other surfaces as the user removes the mask.

The coating may be an anti-viral coating which inactivates or kills viral pathogens on contact.

The coating may be an antibacterial coating which may be applied as the sole anti-pathogenic coating or it may be provided in conjunction with an anti-viral coating.

The concentration of the coating may be higher in the centre of the substrate than at the edges. The concentration of the coating can be varied in order to mirror the expected usage pattern of the filter so the areas that are likely to receive the higher airflow and correspondingly high concentration of droplets potentially containing pathogens to be acted upon by the coating, are provided with higher concentration of the coating.

The concentration of the coating can therefore be tapered towards the edges of the filter where the filter abuts the seams of the face mask because the prevalence of liquid droplets is much reduced.

The coating may be provided on less than 90% of the substrate. Under certain circumstances, parts of the substrate that are least likely to have liquid droplets incident on them are not provided with any coating.

The porosity of the substrate with the coating may be substantially the same as the porosity of the substrate without the coating. The application of the coating without excess of fluid and without pore blocking means that the porosity of the substrate is unchanged by the application of the coating.

The quantity of coating applied to the substrate may be equal to or below the saturated absorbance capacity of the substrate.

The substrate may be made up of more than one layer and the coating penetrates only one layer. For example the substrate may be made up of four layers of equal thickness and the coating penetrates only one layer. Therefore the coating penetrates no more than 25% of the substrate.

The substrate may have a predetermined thickness and the coating penetrates less than 50%, less than 40%, less than 30%, less than 20%, less than 10% or even less than 5% of the thickness of the substrate.

The porous substrate may have a front face and a reverse face and wherein the coating is provided to both the front face and the reverse face. The coating pattern may be different on the front face from the reverse face. The coating on the inside of the filter or reverse face, which is positioned facing the user when the mask is deployed may be concentrated around the high airflow regions adjacent the user's mouth and nose. Conversely, the coating on the outside of the filter or front face, which is positioned facing the world when the mask is deployed, may have a more homogeneous coverage.

The coating may further comprise a dye. The dye indicates the location of the coating on the substrate and therefore enables the user to correctly orient the filter within the mask. For example, ensuring that the front face and reverse faces of the filter are correctly positioned and also ensuring that the filter is not upside down.

The filter may further comprise an indicator mark, which may be a mark made in security ink to confirm that the article is genuine. Alternatively or additionally, the indicator mark can confirm the integrity of the filter. For example, the indicator mark can change colour when the filter has expired and should be replaced. For example, the indicator mark may not become visible until the filter expires at which point the indicator mark may show that the filter should be replaced.

The filter as heretofore described may be incorporated into a face mask comprising at least one layer including a pocket for the filter.

The mask may comprise multiple layers, one of which includes the pocket for the filter. The mask may further comprise fixings to attach the mask to the user. The fixings may be configured to attach to the user's ears or around the user's head.

The mask may further comprise a nose clip. In this context a nose clip is any strengthening or wire that conforms around the user's nose to help to ensure that the mask remains in close contact with the face so that there is substantially no ingress or egress between the user's face and the mask.

The face mask may be washable. The face mask is made from a washable fabric so that it can be washed and reused with a fresh filter inserted into the pocket.

Furthermore, according to the present invention there is provided a method of manufacturing a filter as described above, the method comprising the steps of: providing a roll of substrate material on a vacuum conveyor belt, providing a coating to at least part of the substrate using an array of digitally controlled nozzle dispensers, cutting the roll of substrate into individual filters as described above.

The vacuum conveyor belt ensures that the roll of substrate, or the individual filters, if cut before coating, remain in place during the coating step. The strength of the vacuum influences the penetration of the coating into the substrate.

The step of providing a coating may comprise the sub-steps of: atomising the coating fluid using an 2D array of nozzles to generate a pattern, directing the flow of atomised droplets into the substrate with an applied airflow to control the 3D distribution, drying or fixing the chemistry to provide a homogeneous coating that minimally affects the pore structure of the filter material. The advantage of creating a pattern using the coating is that it minimises consumption of the coating so that only those parts of the substrate that will form the individual filters have coating applied to them. Additionally, within the areas of the substrate that will form filters there is the ability, through the 2D array, to create a pattern which provides areas of high functionality and areas of low functionality.

The step of cutting the roll of substrate may either precede or follow the step of applying the coating.

The method of manufacturing a filter may further comprise the step of providing an indicator mark using a further array of digitally controlled nozzle dispensers.

Problem to solve: Effective inactivation of live pathogens entrapped in a filter with bioactive coating chemistry

Solution: 3D targeted application of anti-viral and anti-bacterial chemistry applied using a digitally controlled spray application system.

Furthermore, a coating process is provided for an air filter wherein the filter material is coated with a 3D-targeted fluid chemistry that inactivates pathogens on contact. The coating may be atomised by a 2D array of digitally controlled nozzle dispensers. The 2D pattern of the coating application may be determined by digital data which turns the nozzles on and off to determine the pattern. An under-web vacuum may be applied with a controlled flow rate to determine the penetration of the coating fluid into the porous media to control 3D distribution of the coating

A coated air filter that is suitable for use in a facemask application is provided. The filter may be a discrete coupon of multi-layer filtration material. The filter may be a pre-defined size and shape suitable for use in a washable facemask. The coating may be applied to one side of the filter only. The coating may not reduce the porosity or filtration performance of the filter.

The coating chemistry may be a fluid and is based on any of the following bioactive ingredients:
a. Antibacterial molecules e.g: doxycycline
b. Proteins/peptides e.g: Magainin
c. Metal ions e.g: silver+
d. Metals: e.g: silver particles
e. Vesicles e.g: phosphorylcholine
f. Elemental fluids e.g: Iodine
g. Free radicals e.g: hydroxyl
h. Reactive chemistry e.g: ozone emitting

The coating chemistry may be provided in a carrier fluid which may be water, an organic solvent or a hot melt.

The quantity of coating to be dispensed onto the textile may be equal to or below the saturated absorbance capacity of the textile, the saturated absorbance capacity being determined based at least in part on the one or more parameters.

Quality assurance procedures may be provided including the steps of detecting an inconsistency in the array of flow channel dispensers and controlling, by a processor, at least one or more of the flow channel dispensers and/or an airflow applied to the dispensed coating to adjust the flow rate or flow trajectory of dispensed coating to compensate for the detected inconsistencies.

The flow channel dispensing tips may be ultrasonic atomiser nozzles.

An airflow may be used to direct a liquid droplet into the internal structure of a textile substrate. For example, a vacuum pump may provide a negative pressure to fold the filter material in place and also to control the depth of penetration of the coating into the substrate. Conversely, a positive pressure may be provided from an air source above the substrate.

The flow channel dispensers may be configured with their dispensing tips at a distance of between 5 mm and 50 mm from the textile surface.

A method of digitally controlled application and fixation of bioactive coating to a porous filter roll or component, such as a facemask filter, on a processing line is provided. The method comprising the steps of: atomising the coating fluid using an 2D array of nozzles to generate a pattern, directing the flow of atomised droplets into the structure with an applied airflow to control the 3D distribution, drying or fixing the chemistry to provide a homogeneous coating that minimally affects the pore structure of the filter material.

The subject of this invention is the use of a spray coating technology that enables control over the three-dimensional distribution of the fluid chemistry using a digitally controlled array of spray nozzles. The invention is focussed on the utility of the technique to deliver more effective bioactive coatings, such as antiviral and antibacterial, to porous media such as filters for facemasks.

The present invention will now be described, by way of example only, with reference to the accompanying drawings in which:

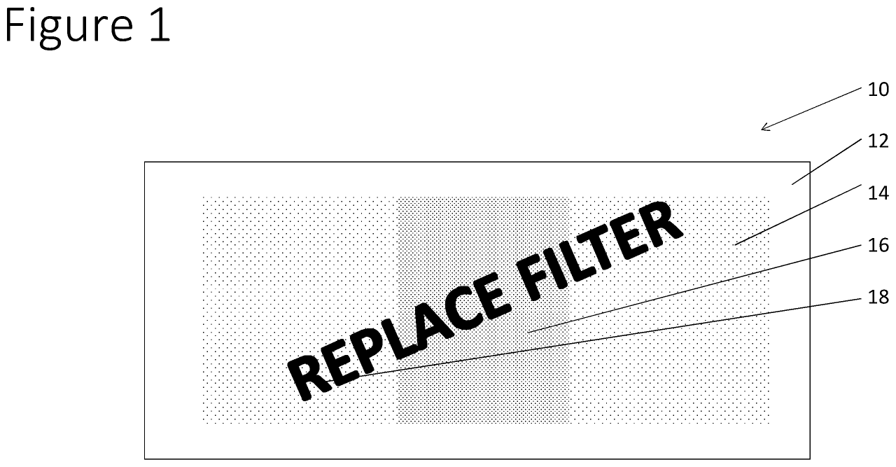

FIG. 1 shows a filter according to the present invention;

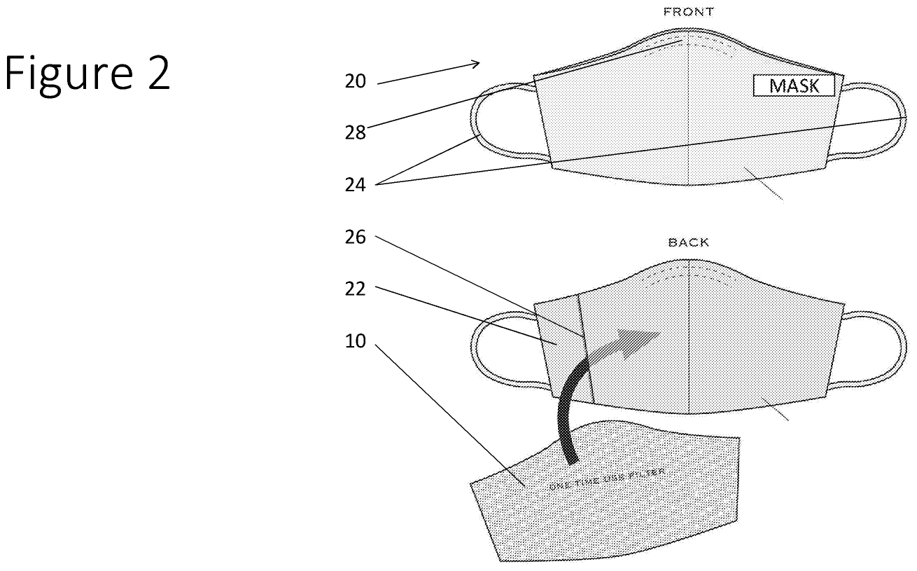

FIG. 2 shows a mask comprising the filter of FIG. 1;

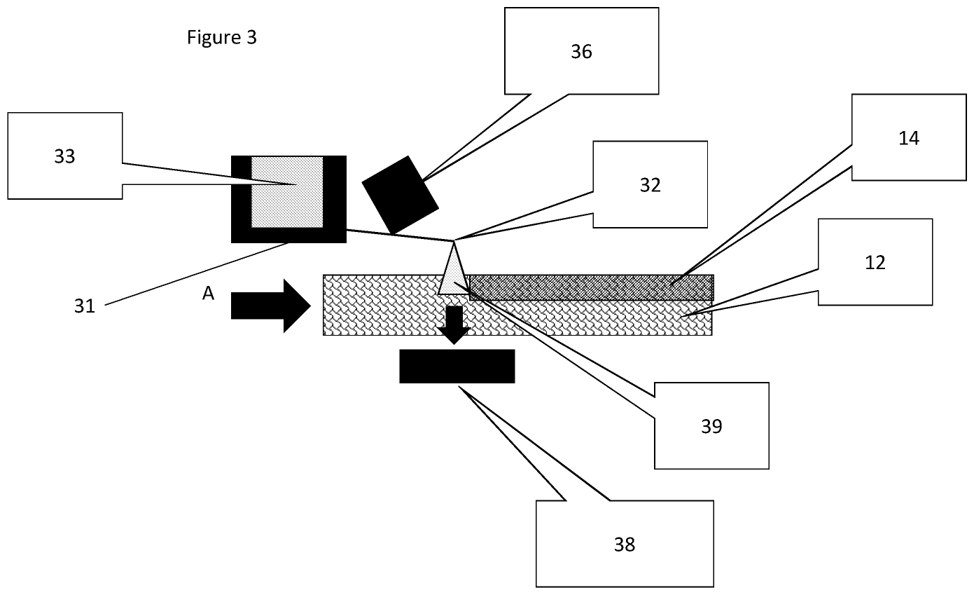

FIG. 3 is a schematic of the 3D coating of the filter of FIG. 1;

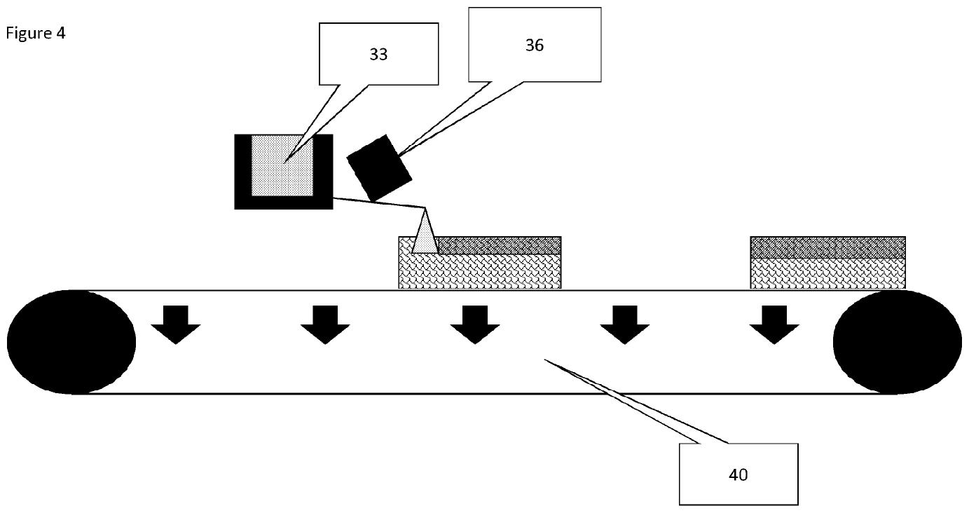

FIG. 4 is a side view of an apparatus for manufacturing filters of FIG. 1; and

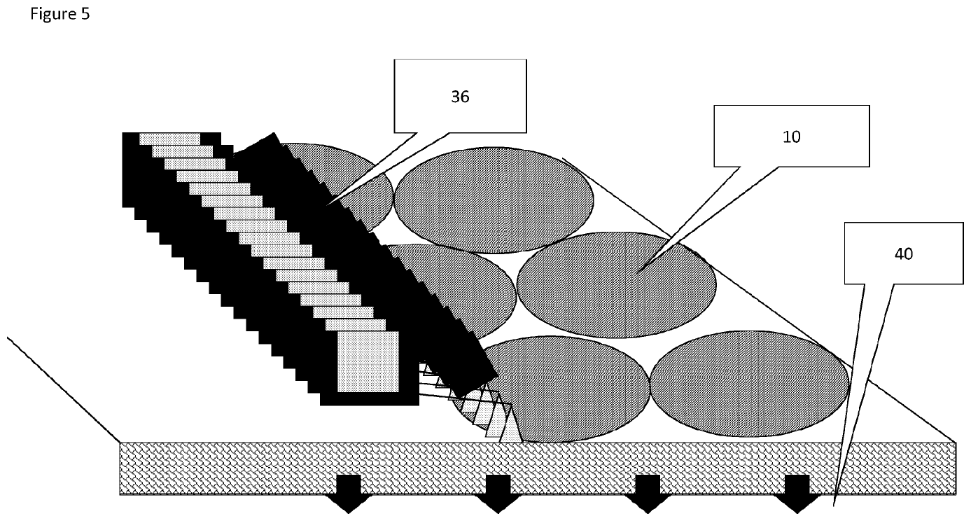

FIG. 5 is a part perspective view of an alternative apparatus for manufacturing filters of FIG. 1.

FIG. 1 shows a filter 10 which includes a porous substrate 12 and an anti-pathogenic coating 14 applied over at least part of the surface. In the illustrated example the coating 14 is applied over the majority of the filter 10, the only exception being the edges of the filter. There is an area 16 that is central between the left and right sides and extends substantially across the full height of the coated area that has a higher concentration of coating material. This area is selected as it is the part of the filter 10 that will experience the highest air flow, in use. It is therefore the area where pathogens are most likely to contact and therefore the area where the anti-pathogenic coating is most needed.

The substrate 12 is a multilayer substrate that is made up of four layers. In other examples, there may be 2, 3, 5, 6, 7, 8 or more layers. The substrate 12 has a reverse face (shown in FIG. 1) and a front face (not shown). The front face, which faces the world, in use, is more likely to have a homogenous coating, rather than the concentration gradient shown for the reverse face in FIG. 1.

The coating 14 includes a dye so that there is a witness to the location and configuration of the coating on each side of the filter 10. The darker the dye, the higher the concentration both of dye particles and anti-pathogenic coating. This provides the user with an intuitive indication as to the correct orientation of the filter within a mask as the high concentration area needs to be adjacent to the nose and mouth of the user.

The filter 10 also includes an indicator mark 18. In the illustrated example, the indicator mark 18 is a text mark that reads “replace filter” and this mark will only become visible when the coating 14 has expired or been compromised. In other examples, not shown in FIG. 1, the indicator mark can be a trade mark or other branding logo printed in security ink to reassure the user that the filter 10 is a genuine product provided by the brand holder.

FIG. 2 shows a mask 20 having one or more layers of fabric 22; one or more fixings 24 and a pocket 26 into which the filter 10 is inserted. The filter 10 shown in FIG. 2 is shaped to conform to the mask 20 rather than being a simple rectangle as shown in FIG. 1. The filter 10 can take any suitable shape and the level of conformity to the mask 20 will depend on how customised the filter 10 is to a particular mask or, conversely, how universally applicable the filter 10 may be. The mask 20 of FIG. 2 has three layers, one of which includes the pocket 26. The fixings 24 are ear loops and are elastic so that they stretch around the user's ears. However, in other examples, not shown in the accompanying drawings, the fixings may be elastic loops to go around the head of the user. The mask 20 also includes a nose clip 28 which, in the illustrated example is a wire to aid the close conformance of the mask 20 to the user's face to ensure that air does not flow around the mask and into the user's mouth and nose, but rather the air preferentially flows through the filter 10. The nose clip 28 may not be required, depending on the selection of the material from which the mask 20 is formed and on the shaping of the layers of fabric and the type of fixing selected.

FIG. 3 shows an apparatus 30 for providing the three-dimensional control of the application of a coating 14 to a porous substrate 12. The coating fluid is provided in a header tank 31. The coating fluid 33 comprises an anti-pathogenic chemistry and a carrier. The carrier may be water, a solvent or a hot melt. Coating of the filter 10 is achieved by utilising an array 32 comprising a plurality of individually addressable spray nozzles 34 that can be turned on and off by digital data to coat a digitally-defined image or pattern. The nozzles 34 are actuated by an array of piezoelectric actuators 36 with one piezoelectric actuator being provided to each spray nozzle 34. The actuation of the piezoelectric actuators 36 results in the issuance of an atomised fluid spray 39 of the coating material onto the filter 10. As the filter 10 moves in the direction A indicated in FIG. 2, this enables 2D control of the applied pattern at up to 50 dots per inch resolution, i.e. with a resolution between 5 mm and 0.5 mm.

Beneath the filter 10 there is provided a vacuum pump 38 which controls the level of penetration of the coating material into the filter 10. The penetration of the coating into the fabric is controlled by airflow through the substrate, which is applied by an under-web vacuum, which determines the depth of penetration of the coating. By combining two-dimensional patterning with control over the coating penetration, it is possible to precisely deposit the coating to substantially eliminate any pore filling and deliver the coating dose required to coat the fibres only with 3D control over coating placement.

FIG. 4 shows a configuration where the filters 10 are cut from a roll of porous substrate before they are printed with the coating material. The vacuum pump 38 is situated within a vacuum conveyor belt 40 which holds the filters 10 firmly in place whilst they are coated. The vacuum conveyor belt 40 is configured to move the filters 10 from left to right in the illustration. The apparatus 30 includes a control system (not shown) which instructs the piezoelectric actuators 36 to turn on and off as each filter 10 is positioned for coating. This ensures that there is no wastage of the coating fluid 33 as the piezoelectric actuators are only active when a filter 10 is present and therefore the volume of coating fluid 33 used is minimised.

The coating application method utilises the capability to print two-dimensional patterns and is uniquely suitable for coating discrete substrate ports, such as filters for facemasks or elements of a filter cartridge. These discrete elements can be presented to the coating system on a transport system such as a conveyer belt 40, which presents the parts to the coating system. The coating system can be switched on and off using a stream of digital data from the line. The coatings can be applied to pre-defined areas based a digital image.

FIG. 5 shows an alternative configuration in which the roll of porous material is provided prior to cutting into filters 10. The coating is applied in discrete shapes and the cutting follows the printing. Again, as with the configuration shown in FIG. 4, there is no wastage of coating fluid 33 because the piezoelectric actuators are controlled only to dispense in the areas where the coating is desired.

In conjunction with the examples of FIGS. 4 or 5, there may be further provided a separate array of individually addressable spray nozzles that can print an indicator mark. This can be one or more of a quality assurance mark such as a branding logo or trade mark shown in security ink to assure the user that the product is genuine. Alternatively or additionally the indicator mark can be a usage mark that indicates when the anti-pathogenic materials in the coating have expired or been compromised.

The array of flow channel dispensers disclosed herein, which are based on those configured in the printhead disclosed in WO 2017/187153, are particularly suited to the present method. The array has the features of a digitally controllable fluid flow both in the conveyance direction and cross direction, highly accurate deposition, high cross-web homogeneity, the possibility of instant image changeovers due to the digital control of the elements, and a high droplet velocity of greater than 5 ms⁻¹ to ensure penetration into the textile and with the addition of a parallel airflow applied below or above the substrate but without further adsorption encouraging steps.

A key application for this invention is in the coating of facemask filters for reduction of human-to-human pathogen transmission. The application of anti-pathogen chemistry to filters within facemasks has the potential to reduce the transmission to the user, when handling the facemask or breathing through the facemask in the case where it has been contaminated by a pathogenic microorganism or virus. Examples of the pathogens, which may be present include:
1. Streptococcus pneumoniae,
2. Haemophilus influenzae,
3. Staphylococcus aureus,
4. Moraxella catarrhalis) and seven common respiratory viruses
5. Rhinoviruses (hRV),
6. Respiratory syncytial virus (RSV),
7. Adenoviruses (AdV),
8. Coronavirus (CoV),
9. Influenza viruses (IV),
10. Para-influenza viruses (PIV),
11. Human metapneumovirus (hMPV))

This invention is designed to enable the industrial production of anti-viral chemistry coated facemask filters based on several unique aspects to the technology:
1. Capability to 2D pattern, depositing the chemistry on a discrete substrate item
2. Capability to control penetration of the coating into the substrate using airflow
3. Capability to coat the chemistry with very low level of pore filling due to the distribution of liquid within the filter structure
4. Capability to deposit the coating onto one or two sides of the substrate.

Furthermore, it has been found that this method of coating application, wherein the coating is finely dispersed over the surface structures of the filter membrane materials results in coatings that are more effective on a mass basis. This enables less coating to be applied to deliver the same level of biological activity.

### Example 1

Deposition of silver containing aqueous chemistry onto a four-layer facemask filter. The silver containing coating chemistry is applied as a water-based suspension at 10 wt % to a four-layer PM2.5 (2.5 micron) filter using the digital spray array. An airflow of ˜10 m/sec is applied to the underside of the filter using a vacuum conveyer belt and the coating is dispensed in a 2D pattern that matches the shape of the filter. The airflow is selected to localise the coating on the top layer of the four-layer filter, maximising the concentration of the coating in the layer that will be in contact with airborne pathogens entering a facemask from outside.

The coated filter was tested for antibacterial efficacy of the filter was tested according to ISO 20743:2013 and it was found that >99.9% of test bacteria (Bacterium: Staphylococcus aureus) (ATCC6538P) were inactivated by the material. The test result indicated that the biological activity of the coating applied using the method according to the invention is more effective than when the coating is applied using traditional coating techniques.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1. A removable filter comprising:
a porous substrate; and
an anti-pathogenic coating provided on at least part of the porous substrate
wherein the concentration of the coating varies across the substrate to provide a coating pattern.

2. The filter according to claim 1, wherein the coating is an anti-viral coating.

3. The filter according to claim 1 or claim 2, wherein the coating is an antibacterial coating.

4. The filter according to any one of the preceding claims, wherein the coating pattern is a 2-dimensional coating pattern.

5. The filter according to any one of the preceding claims, wherein the concentration of the coating is higher in the centre of the substrate than at the edges.

6. The filter according to any one of the preceding claims, wherein the coating is provided on less than 90% of the substrate.

7. The filter according to any one of the preceding claims, wherein the porosity of the substrate with the coating is substantially the same as the porosity of the substrate without the coating.

8. The filter according to any one of the preceding claims, wherein the quantity of coating applied to the substrate is equal to or below the saturated absorbance capacity of the substrate.

9. The filter according to any one of the preceding claims, wherein the substrate is made up of more than one layer and the coating penetrates only one layer.

10. The filter according to any one of the preceding claims, wherein the substrate has a predetermined thickness and the coating penetrates less than 50% of the thickness of the substrate.

11. The filter according to any one of the preceding claims, wherein the substrate has a predetermined thickness and the coating penetrates less than 5% of the thickness of the substrate.

12. The filter according to any one of the preceding claims, wherein the porous substrate has a front face and a reverse face and wherein the coating is provided to both the front face and the reverse face.

13. The filter according to claim 12, wherein the coating pattern is different on the front face from the reverse face.

14. The filter according to any one of the preceding claims, wherein the coating further comprises a dye.

15. The filter according to any one of the preceding claims, wherein the filter further comprises an indicator mark.

16. The filter according to claim 15, wherein the indicator mark is provided using a security ink.

17. The filter according to claim 15 or claim 16, wherein the indicator mark confirms the integrity of the filter.

18. A face mask comprising at least one layer including a pocket for a filter according to any one of claims 1 to 17.

19. The face mask according to claim 18, wherein the mask comprises multiple layers, one of which includes the pocket for the filter.

20. The face mask according to claim 18 or claim 19, further comprising fixings to attach the mask to the user.

21. The face mask according to claim 20, wherein the fixings are configured to attach to the user's ears.

22. The face mask according to claim 20, wherein the fixings are configured to attach around the user's head.

23. The face mask according to any one of claims 18 to 22, further comprising a nose clip.

24. An air purification device comprising at least one filter according to any one of claims 1 to 17.

25. A method of manufacturing a filter according to any one of claims 1 to 17, the method comprising the steps of:
providing a roll of substrate material on a vacuum conveyor belt,
providing a coating to at least part of the substrate using an array of digitally controlled nozzle dispensers,
cutting the roll of substrate into individual filters according to any one of claims 1 to 17.

26. The method according to claim 25, wherein the step of providing a coating comprises the sub-steps of:
atomising the coating fluid using an 2D array of nozzles to generate a pattern,
directing the flow of atomised droplets into the substrate with an applied airflow to control the 3D distribution,
drying or fixing the chemistry to provide a homogeneous coating that minimally affects the pore structure of the filter material.

27. The method according to claim 25 or claim 26, wherein the step of cutting the roll of substrate precedes the step of applying the coating.

28. The method according to claim 25 or claim 26, wherein the step of cutting the roll of substrate follows the step of applying the coating.

29. The method according to any one of claims 25 to 28, further comprising the step of providing an indicator mark using a further array of digitally controlled nozzle dispensers.
